(19) United States
(12) Patent Application Publication
(10) Pub. No.: US 2023/0396811 A1
(43) Pub. Date: Dec. 7, 2023

(54) METHOD AND ELECTRONIC DEVICE FOR PROCESSING VIDEO CODING

(71) Applicant: REALTEK SEMICONDUCTOR CORP., Hsinchu (TW)

(72) Inventors: Wei-Min Zeng, Milpitas, CA (US); Chi-Wang Chai, Cupertino, CA (US); Wei Li, Suzhou (CN); Jing Wang, Suzhou (CN); Wu-Jun Chen, Suzhou (CN)

(73) Assignee: REALTEK SEMICONDUCTOR CORP., Hsinchu (TW)

(21) Appl. No.: 17/829,739

(22) Filed: Jun. 1, 2022

(51) Int. Cl. H04N 19/96; H04N 19/147; H04N 19/105; H04N 19/176

(52) U.S. Cl. CPC H04N 19/96; H04N 19/147; H04N 19/105; H04N 19/176

(57) ABSTRACT

A method and an electronic device for processing video coding are provided. The electronic device for processing video coding includes a storage unit, a coding tree generation module, and a decision tree module. The storage unit stores an input video. The input video includes a plurality of frames. The electronic device for processing video performs following steps of: acquiring a target block in each of the frames, where the target block has at least one coding unit; loading the target block to the coding tree generation module to output a first coding tree and a second coding tree; generating an output decision tree according to the first coding tree and the second coding tree; and outputting streaming data according to the output decision tree and the frames.

### BACKGROUND

### Technical Field

The present disclosure relates to a method and a device for processing coding on a digital signal, and in particular, to a method and an electronic device for processing video coding.

### Related Art

The rapid development of the Internet also drives the rise of video streaming. In order to reduce the data transmission amount, it is necessary to process video coding of an input digital image. During the video coding, the input image is divided into a plurality of different data blocks, and a corresponding coding tree is generated according to a coding unit in the data block to predict momenta of other frames. Since the input image having higher resolution generates more data blocks and coding units, generation loads of the decision tree are correspondingly increased.

### SUMMARY

In view of the above, the present disclosure provides a method for processing video coding, for performing coding prediction on a plurality of frames of an input image to generate output streaming data. The method for processing video coding can maintain the same coding quality and reduce computational complexity of a hardware coder.

The method for processing video coding of the present disclosure includes the following steps: acquiring a target block in each of the frames; splitting the target block into at least one coding unit; loading the target block to a coding tree generation module to output a first coding tree and a second coding tree; calculating, by an integer motion estimation (IME) unit of the coding tree generation module, a rate-distortion cost of each coding unit, and selecting a smallest one and a second smallest one from the rate-distortion costs, where the smallest rate-distortion cost is a first integer estimation result, and the second smallest rate-distortion cost is a second integer estimation result; generating an output decision tree according to the first coding tree and the second coding tree; outputting streaming data according to the output decision tree and the frame. Different coding trees are processed by using corresponding rate-distortion costs, to reduce computational loads of the coding trees.

The step of selecting the smallest one and the second smallest one from the rate-distortion costs includes: loading the first integer estimation result to a fractional motion estimation (FME) unit of the coding tree generation module to obtain a first fractional estimation result; loading the first fractional estimation result to a coding mode decision unit of the coding tree generation module to obtain the first coding tree; loading the second integer estimation result to the FME unit to obtain a second fractional estimation result; and loading the second fractional estimation result to the coding mode decision unit to obtain the second coding tree.

The step of loading the target block to the coding tree generation module to output the first coding tree and the second coding tree includes: selecting a first reference frame; loading the first integer estimation result to an FME unit in a low delay P frame (LDP) mode according to the first reference frame, a first coding block, and a second coding block, to acquire the first coding tree; loading the second integer estimation result to the FME unit in the LDP mode according to the first reference frame, the first coding block, and the second coding block, to acquire the second coding tree; selecting a first node unit from the first coding tree and a second node unit from the second coding tree according to the first coding block, where a node position of the second node unit in the second coding tree corresponds to a node position of the first node unit in the first coding tree; selecting a first node unit from the first coding tree and a second node unit from the second coding tree according to the first coding block, where a node position of the second node unit in the second coding tree corresponds to a node position of the first node unit in the first coding tree; selecting one of the first node unit or the second node unit as an output unit according to the coding units in the first node unit and the second node unit; selecting one of the third node unit or the fourth node unit as another output unit according to the coding units in the third node unit and the fourth node unit; traversing the first coding tree and the second coding tree to acquire the corresponding output units, and generating an output decision tree according to the selected output units.

The step of loading the target block to the coding tree generation module to output the first coding tree and the second coding tree includes: selecting a first reference frame and a second reference frame; loading the first integer estimation result to an FME unit in an LDP mode according to the first reference frame ; the second reference frame, and a first coding block, to acquire the first coding tree; loading the second integer estimation result to the FME unit in a random frame access mode according to the first reference frame, the second reference frame, and a second coding block, to acquire the second coding tree; selecting a first node unit from the first coding tree and a second node unit from the second coding tree according to the first coding block, where a node position of the second node unit in the second coding tree corresponds to a node position of the first node unit in the first coding tree; selecting a third node unit from the first coding tree and a fourth node unit from the second coding tree according to the second coding block, where a node position of the fourth node unit in the second coding tree corresponds to a node position of the third node unit in the first coding tree; selecting one of the first node unit or the second node unit as an output unit according to the coding units in the first node unit and the second node unit; selecting one of the third node unit or the fourth node unit as another output unit according to the coding units in the third node unit and the fourth node unit; and traversing the first coding tree and the second coding tree to acquire the corresponding output units, and generating an output decision tree according to the selected output units.

An electronic device for processing video coding includes a storage unit, a coding tree generation module, and a decision tree module. The storage unit is configured to store an input image. The input image includes a plurality of frames. The coding tree generation module is configured to acquire a target block from any of the frames and generate a first coding tree and a second coding tree according to the target block. The decision tree module is configured to receive the first coding tree and the second coding tree and generate an output decision tree according to a plurality of rate-distortion costs of the first coding tree and the second coding tree.

The coding tree generation module further includes an IME unit, an FME unit, and a coding mode decision unit. The IME unit generates a first integer estimation result and a second integer estimation result according to the target block. The FME unit generates a first fractional estimation result according to the first integer estimation result, and generates a second fractional estimation result according to the second integer estimation result. The coding mode decision unit generates a first coding tree and a second coding tree according to the first fractional estimation result and the second fractional estimation result. The IME unit is configured to select a smallest one of the rate-distortion costs as the first integer estimation result, and select a second smallest one of the rate-distortion costs as the second integer estimation result.

According to the method and the electronic device for processing video coding in the present disclosure, coding prediction is performed on the plurality of frames of the input image to output streaming data. In the method for processing video coding, the coding trees are divided in advance, to generate two different sets of coding trees. Different coding trees are processed by using corresponding rate-distortion costs, to reduce computational loads of the coding trees. The output decision tree is generated according to nodes formed by the first coding tree and the second coding tree. The method for processing video coding can reduce the computational complexity of a hardware coder and can maintain the same coding quality.

### BRIEF DESCRIPTION OF THE DRAWINGS

FIG. 1 is a schematic diagram of a hardware structure of an electronic device for processing video coding according to an embodiment of the present disclosure.

FIG. 2 is a schematic diagram of a target block and coding units according to an embodiment of the present disclosure.

FIG. 3A is a schematic flowchart of processing video coding according to an embodiment of the present disclosure.

FIG. 3B is a schematic flowchart of generating a first coding tree and a second coding tree according to an embodiment of the present disclosure.

FIG. 4A is a schematic diagram of a processing flow of generating coding trees in a low delay P frame (LDP) mode according to an embodiment of the present disclosure.

FIG. 4B is a schematic diagram of a first coding tree and each node unit according to an embodiment of the present disclosure.

FIG. 4C is a schematic diagram of a second coding tree and each node unit according to an embodiment of the present disclosure.

FIG. 4D is a schematic diagram of an output decision tree according to an embodiment of the present disclosure.

FIG. 4E is a schematic diagram of another output decision tree according to an embodiment of the present disclosure.

FIG. 5 is a schematic flowchart of generating an output decision tree according to an embodiment of the present disclosure.

FIG. 6A is a schematic diagram of a processing flow of generating each coding tree in an LDP mode according to an embodiment of the present disclosure.

FIG. 6B is a schematic diagram of a first coding tree and each node unit according to an embodiment of the present disclosure.

FIG. 6C is a schematic diagram of a second coding tree and each node unit according to an embodiment of the present disclosure.

FIG. 6D is a schematic diagram of an output decision tree according to an embodiment of the present disclosure.

FIG. 7 is a schematic flowchart of generating an output decision tree according to an embodiment of the present disclosure.

FIG. 8A is a schematic diagram of an operation process of selecting an output unit according to an embodiment of the present disclosure.

FIG. 8B is a schematic diagram of an operation process of selecting an output unit according to an embodiment of the present disclosure.

### DETAILED DESCRIPTION

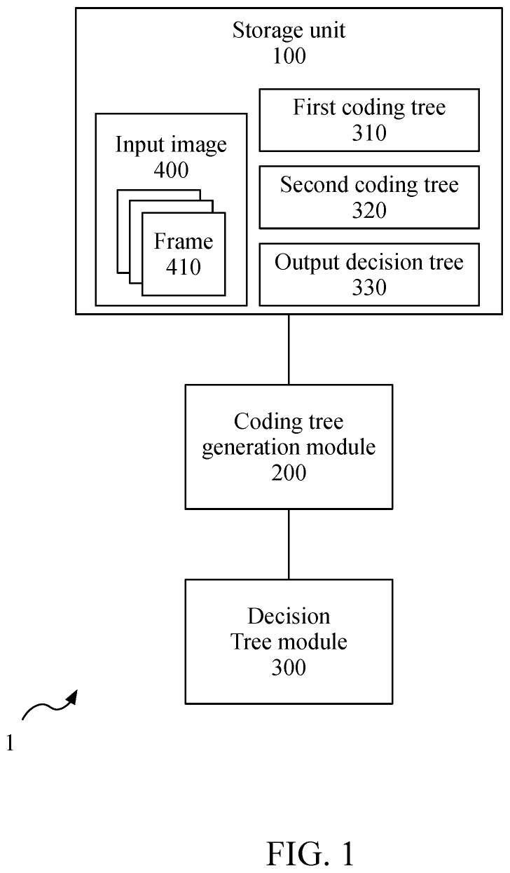

Referring to FIG. 1, FIG. 1 is a schematic diagram of a hardware structure of an electronic device for processing video coding according to an embodiment of the present disclosure. The electronic device 1 for processing video coding (referred to as the electronic device 1 for short in the following and in the figures) includes a storage unit 100, a coding tree generation module 200, and a decision tree module 300. The electronic device 1 is applicable to image coding processing of a digital image. The video coding includes AOMedia Video 1 (AV1 for short), High Efficiency Video Coding (HEVC), or the like. The coding tree generation module 200 and the decision tree module 300 may be run by independent chips, and related functions of the coding tree generation module 200 and the decision tree module 300 may also be implemented by one central processing unit.

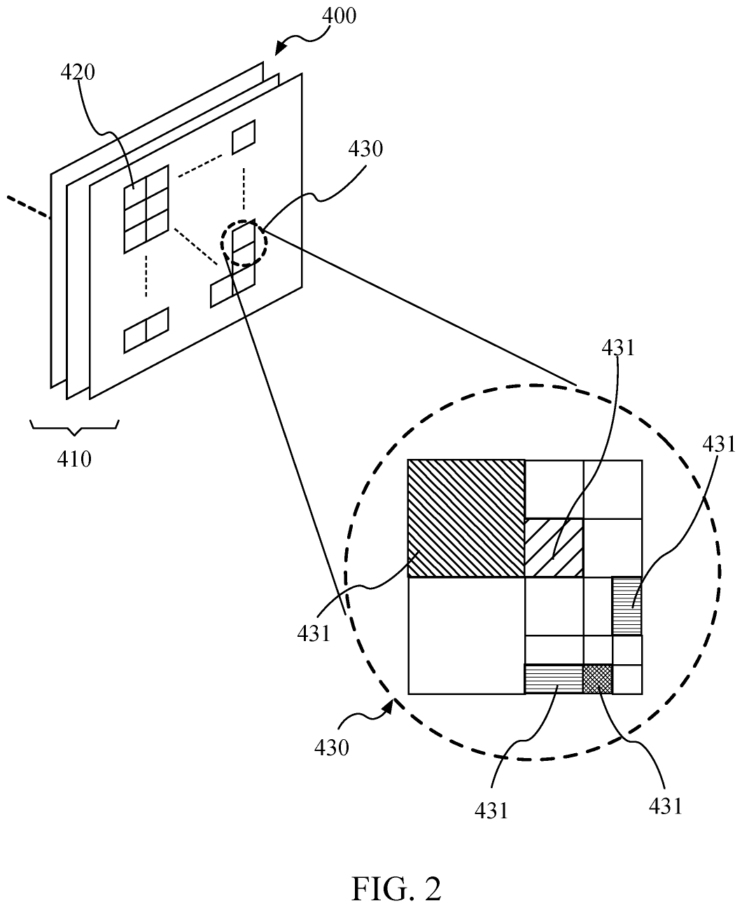

The storage unit 100 stores an input image 400 or temporary data during the image coding. The input image 400 includes a plurality of frames 410. Generally speaking, each frame 410 may be divided into at least one or more super blocks 420. The super block 420 may be selected from luminance samples of the input image 400 in a YUV mode. Referring to FIG. 2, each super block 420 may also be divided into at least one or more coding blocks. For convenience of description below, the selected super block 420 is referred to as a target block 430, and a dashed circle frame in FIG. 2 shows the selected target block 430. The target block 430 has, for example, but not limited to, a size of 64*64 pixels, or may have an array size of 128*128 pixels, which is determined according to the computing capability of the electronic device 1. The target block 430 includes at least one coding unit 431. The coding units 431 included in the target block 430 form a corresponding coding tree structure.

A splitting method for the target block 430 may include “direct split”, “none split”, “horizontal split”, and “vertical split”, As described above, the target block 430 may have a maximum size of 64*64 pixels. As shown in FIG. 2, the target block 430 may be split into coding units 431 having a size of any of 32*32 pixels, 16*16 pixels, 8*8 pixels, 16*8 pixels, or 8*16 pixels. In FIG. 2, in order to facilitate displaying of the target blocks 430 having different sizes, the target blocks 430 having different sizes are arranged in a staggered manner, and the target blocks 430 are not limited to being at a position. The blocks in FIG. 2 filled with different lines represent coding units 431 having different sizes in the target block 430.

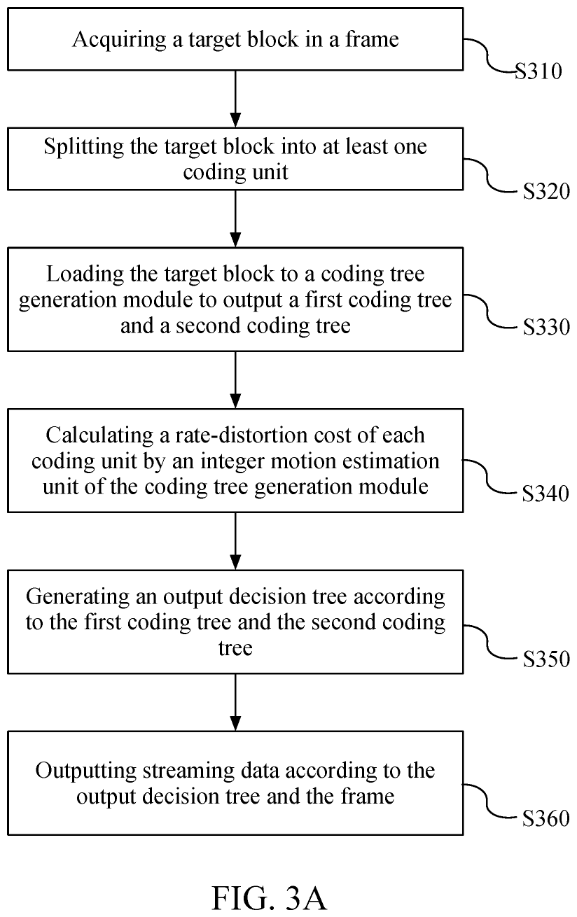

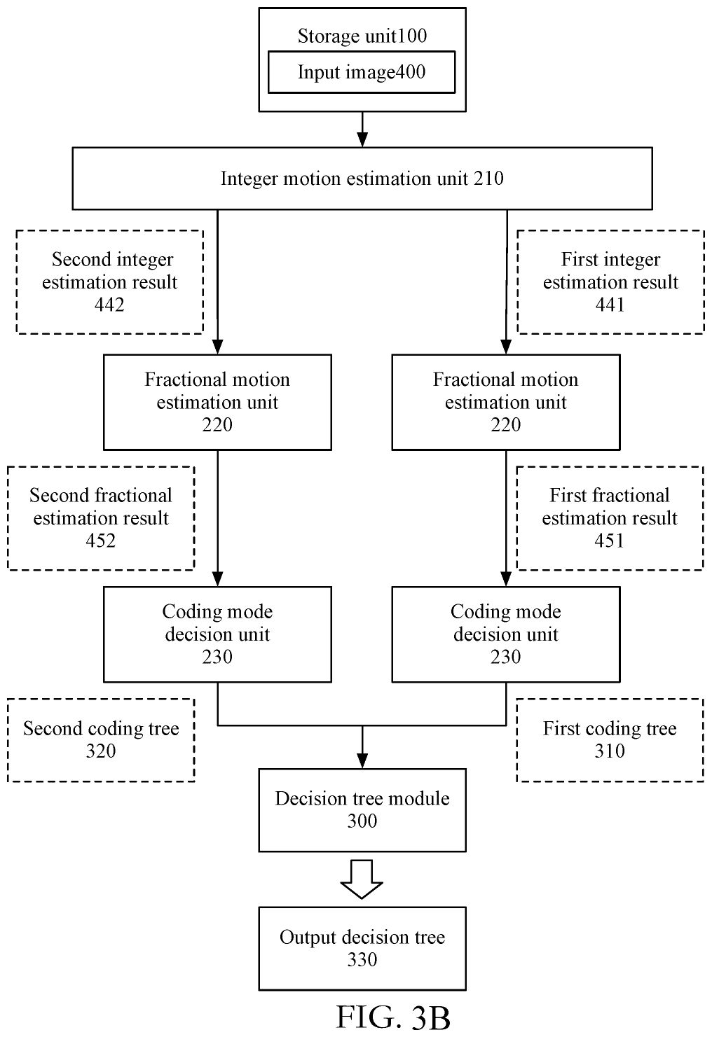

The coding tree generation module 200 reads the input image 400 from the storage unit 100. The coding tree generation module 200 selects any frame 410 from the input image 400, and then selects the target block 430 from the selected frame 410. The coding tree generation module 200 (as shown in FIG. 3B) may include an integer motion estimation (IME) unit 210, a fractional motion estimation (FME) unit 220, and a coding mode decision (Block Mode Decision, BDM) unit 230. The coding tree generation module 200 generates a first coding tree 310 and a second coding tree 320 according to the target block 430. The generation of the first coding tree 310 and the second coding tree 320 is to be described in detail later. The decision tree module 300 receives the first coding tree 310 and the second coding tree 320, and generates a corresponding output decision tree 330 according to rate-distortion costs of the first coding tree 310 and the second coding tree 320. The electronic device 1 outputs streaming data according to the output decision tree 330 and other frames 410.

In order to further describe the generation process of the first coding tree 310 and the second coding tree 320, refer to FIG. 3A and FIG. 3B, which are respectively a schematic flowchart of processing video coding and a schematic flowchart of generating a first coding tree and a second coding tree according to an embodiment of the present disclosure. The method for processing video coding includes the following steps.
Step S310: a target block in each frame is acquired.
Step S320: the target block is split into at least one coding unit.
Step S330: the target block is loaded to a coding tree generation module to output a first coding tree and a second coding tree.
Step S340: a rate-distortion cost of each coding unit is calculated by an IME unit of the coding tree generation module.
Step S350: an output decision tree is generated according to the first coding tree and the second coding tree.
Step S360: streaming data is outputted according to the output decision tree and the frame.

First, the coding tree generation module 200 reads the input image 400 of the storage unit 100, and selects the frame 410 and the target block 430 from the input image 400 (as shown in FIG. 2). The coding tree generation module 200 drives the IME unit 210 and loads the target block 430 to the IME unit 210. The IME unit 210 calculates a rate-distortion cost of the target block 430. The rate-distortion cost may be obtained by using the following formula 1.

$$RD cost = λ R + D , D ∈ \{ SAD , SATD \} \qquad ( Formula 1 )$$

$$SAD = {\sum }_{i , j} \vert Diff ( i , j ) \vert ,$$

$$SATD = \frac{( {\sum }_{i , j} \vert Diff ( i , j ) \vert )}{2} , Diff ( i , j ) = Predictor ( i , j ) - Source ( i , j )$$

where Source is the frame, Predictor is the frame predicted by the IME unit 210, and (i,j) are pixel positions in the foregoing two frames.

The IME unit 210 may select either a sum of absolute differences (SAD) or Hadamard transform during calculation of the rate-distortion costs, to perform the rate-distortion calculation. The IME unit 210 calculates a plurality of rate-distortion costs of the target block 430. The IME unit 210 selects a smallest one and a second smallest one from all of the rate-distortion costs. The smallest rate-distortion cost is referred to as a first integer estimation result 441 below. The second smallest rate-distortion cost is referred to as a second integer estimation result 442.

The IME unit 210 outputs the first integer estimation result 441 and the second integer estimation result 442 to the FME unit 220. In FIG. 3B, in order to facilitate description of generation paths of different coding trees, different FME units 220 are respectively connected to the IME unit 210. However, in fact, the same FME unit 220 may calculate the first integer estimation result 441 and the second integer estimation result 442. The FME unit 220 generates a first fractional estimation result 451 according to the loaded first integer estimation result 441. The FME unit 220 generates a second fractional estimation result 452 according to the loaded second pixel estimation result 442. The FME unit 220 performs operation of the rate-distortion cost by using the SAD.

Next, the FME unit 220 outputs the first fractional estimation result 451 and the second fractional estimation result 452 to the coding mode decision unit 230. The coding mode decision unit 230 may select either the SAD or the SATD for the rate-distortion calculation. The coding mode decision unit 230 obtains the first coding tree 310 according to the first fractional estimation result 451. The coding mode decision unit 230 obtains the second coding tree 320 according to the second fractional estimation result 452. The coding mode decision unit 230 outputs the first coding tree 310 and the second coding tree 320 to the decision tree module 300.

The decision tree module 300 calculates the rate-distortion cost, a frame pixel reconstruction value (Recon), and some related parameters according to the first coding tree 310 and the second coding tree 320. A sum of squared errors (SSE) may be selected as the rate-distortion cost, refer to the following formula 2. The decision tree module 300 acquires an optimal method for splitting into the coding units 431 according to the rate-distortion costs, and the splitting of the coding units 431 leads to generation of the output decision tree 330.

RD cost=λR+D(SSE)

SSE=Σ_{i,j}Diff(i, 2)², Diff(i,j)=Recon(i,j)−Source(i,j). (Formula 2)

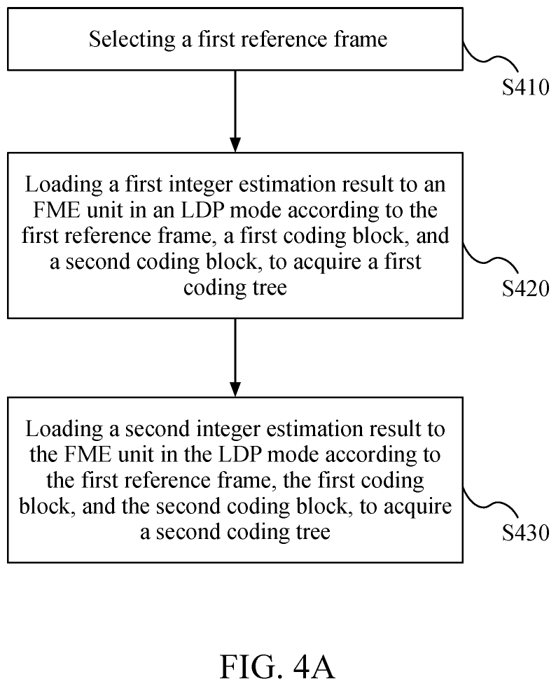

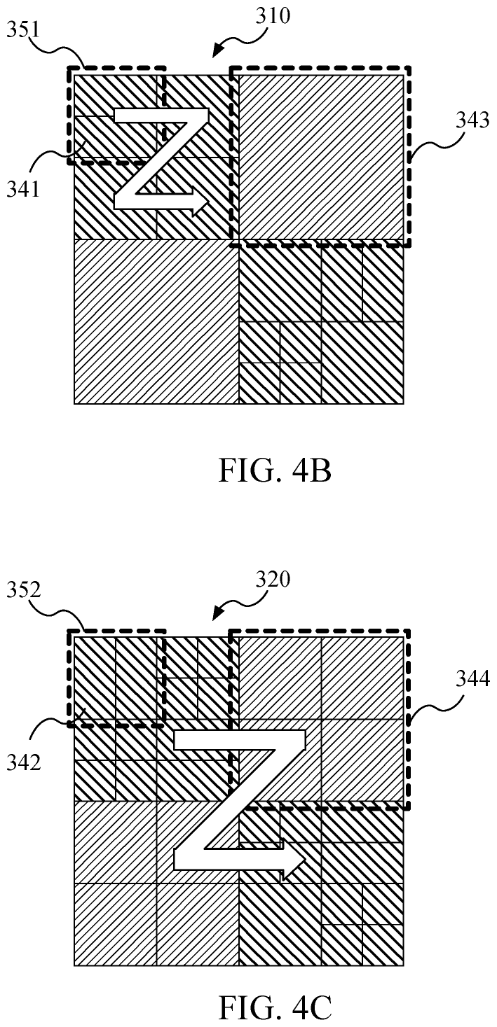

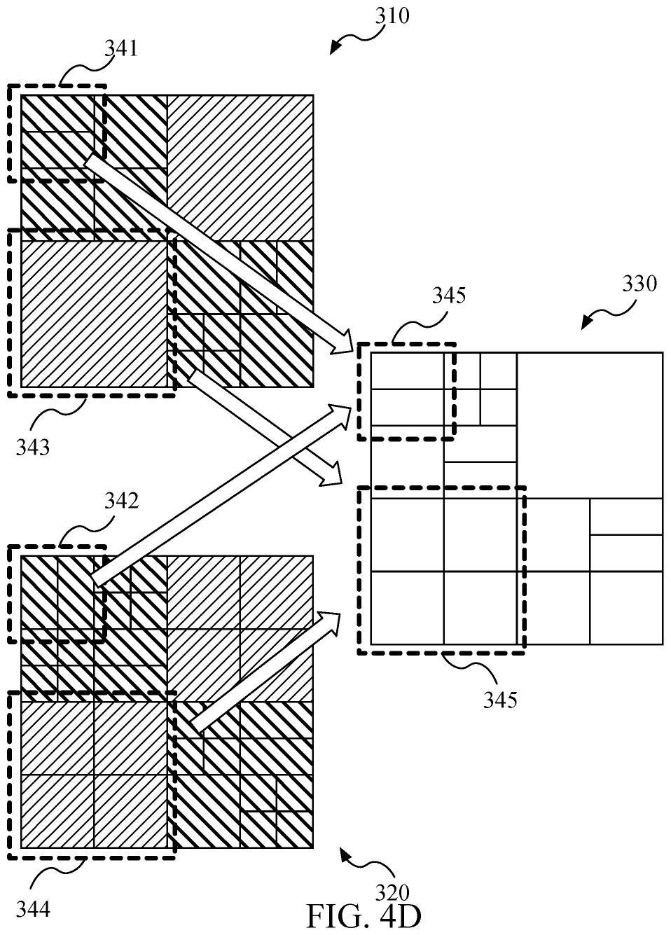

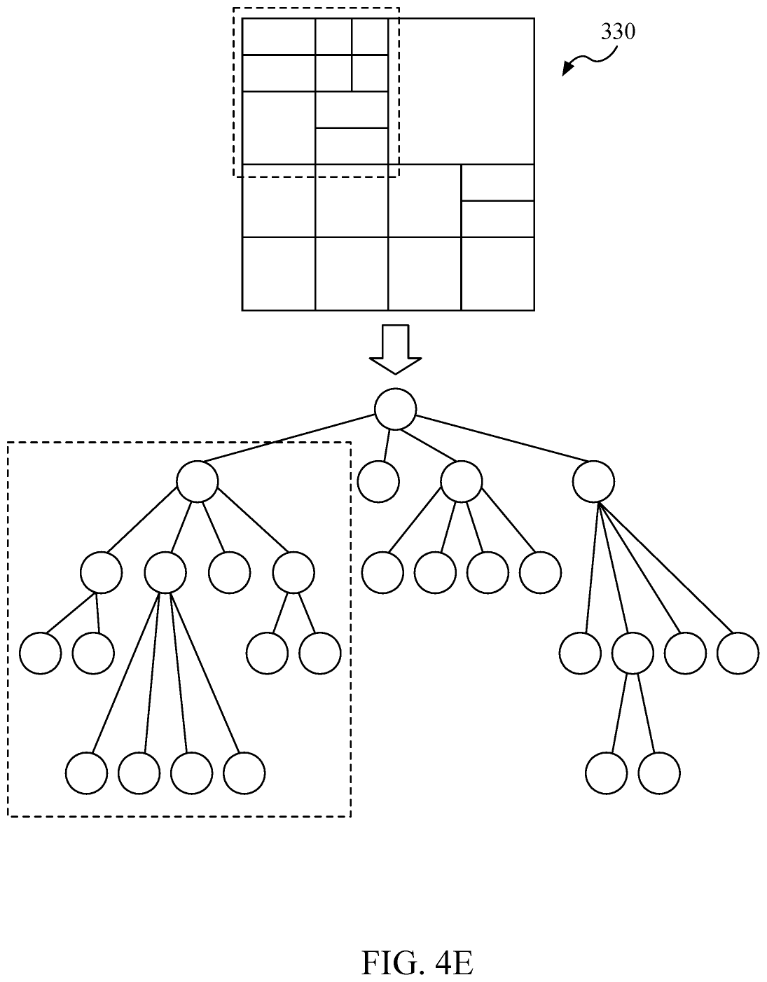

In an embodiment, in the generation process of the first coding tree 310 and the second coding tree 320, the coding trees may be divided according to a reference frame. Referring to FIG. 4A, this embodiment further includes the following processing steps. FIG. 4A is a schematic diagram of a processing flow of generating coding trees in a low delay P frame (LDP) mode according to an embodiment of the present disclosure.
Step S410: a first reference frame is selected.
Step S420: a first integer estimation result is loaded to an FME unit in the LDP mode according to the first reference frame, a first coding block, and a second coding block, to acquire the first coding tree.
Step S430: a second integer estimation result is loaded to the FME unit in the LDP mode according to the first reference frame, the first coding block, and the second coding block, to acquire a second coding tree.

First, an electronic device 1 may select any of frames 410 other than the target block 430 as the first reference frame. Generally speaking, the electronic device 1 may select any of the frame 410, a predicted frame (P frame) 410, an Ultra frame (I frame) 410, or a bi-directional frame (B frame) 410 similar to the target block 430 as the first reference frame.

Next, the IME unit 210 processes the first reference frame, thefirst integer estimation result 441, and the second integer estimation result 442 based on the LDP mode by using the first coding block 351 and the second coding block 352 (as shown in FIG. 4B and FIG. 4C), and acquires the first coding tree 310 and the second coding tree 320. In other words, the IME unit 210 applies the first integer estimation result 441 to the first reference frame, and performs prediction processing of the first coding block 351, the second coding block 352, and the LDP mode. The second integer estimation result 442 also uses the first reference frame as a reference, and performs the prediction processing of the first coding block 351, the second coding block 352, and the LDP mode.

The first coding block 351 has a size of 16*16 pixels, and the second coding block 352 has a size of 32*32 pixels. The first coding block 351 may be formed by a plurality of coding units 431 having smaller sizes (as shown in FIG. 2). For example, the first coding block 351 may be a square matrix formed by four coding units 431 having a size of 8*8 pixels or by two coding units 431 having a size of 8*16 pixels, or include only a single coding unit 431 having a size of 16*16 pixels. However, the second coding block 352 is composed of only the coding unit 431 having a size of 32*32 pixels.

The IME unit 210 performs corresponding prediction processing on the target block 430, and outputs the first integer estimation result 441 and the second integer estimation result 442. For convenience of description, refer to FIG. 4B, FIG. 4C, FIG. 4D, and FIG. 4E, which are respectively schematic diagrams of a first coding tree and each node unit, a second coding tree and each node unit, an output decision tree and another output decision tree according to an embodiment of the present disclosure. Next, the FME unit 220 and the coding mode decision unit 230 perform prediction and division of the coding units 431 on the first integer estimation result 441 and the second integer estimation result 442 according to the first coding block 351, in order to generate the first coding tree 310 and the second coding tree 320. In FIG. 4B and FIG. 4C, blocks filled with backslashes “\,” represent the coding units 431 divided by the first coding block 351 and a combination thereof. In FIG. 4B and. FIG. 4C, blocks filled with slashes “/” represent the coding units 431 divided by the second coding block 352 and a combination thereof.

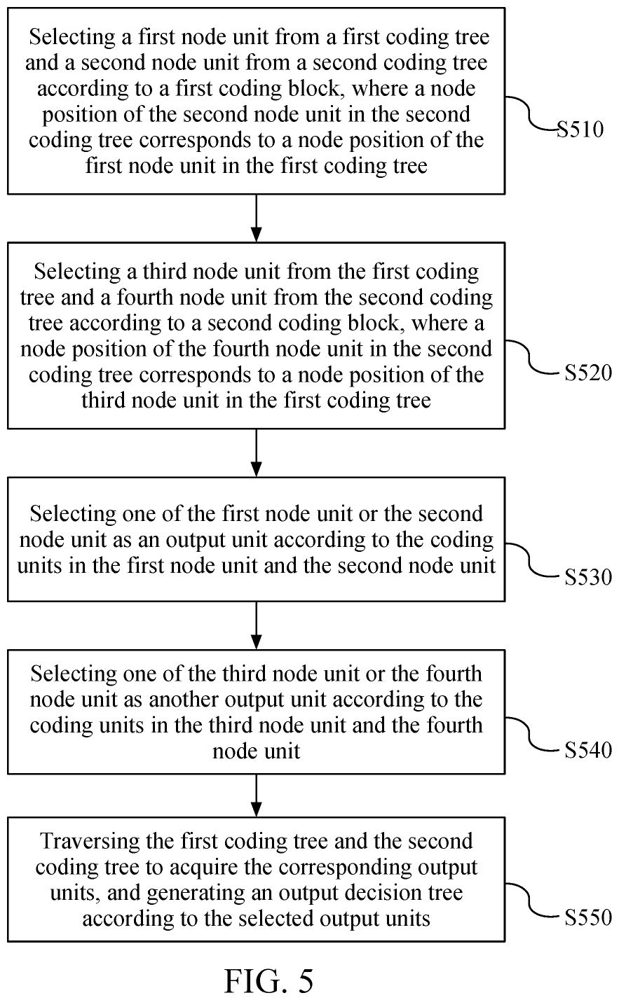

Finally, the coding tree generation module 200 outputs the first coding tree 310 and the second coding tree 320 to the decision tree module 300. The coding tree generation module 200 generates the output decision tree 330 according to the coding units 431 at different positions in the first coding tree 310 and the second coding tree 320. Referring to FIG. 5, FIG. 5 is a schematic flowchart of generating an output decision tree according to an embodiment.
Step S510: a first node unit is selected from the first coding tree and a second node unit is selected from the second coding tree according to the first coding block, where a node position of the second node unit in the second coding tree corresponds to a node position of the first node unit in the first coding tree.
Step S520: a third node unit is selected from the first coding tree and a fourth node unit is selected from the second coding tree according to the second coding block, where a node position of the fourth node unit in the second coding tree corresponds to a node position of the third node unit in the first coding tree.
Step S530: one of the first node unit or the second node unit is selected as an output unit according to the coding units in the first node unit and the second node unit.
Step S540: one of the third node unit or the fourth node unit is selected as another output unit according to the coding units in the third node unit and the fourth node unit.
Step S550: the first coding tree and the second coding tree are traversed to acquire the corresponding output units, and an output decision tree is generated according to the selected

A tree structure relationship among the coding units 431 of the first coding tree 310 and the second coding tree 320 may be obtained from FIG. 4B and FIG. 4C. The decision tree module 300 selects the coding units 431 from the first coding tree 310 by using the first coding block 351, and uses the selected coding units 431 (or a set of coding units 431) as a first node unit 341.

Next, the decision tree module 300 selects a second node unit 342 from the second coding tree 320. A node position of the second node unit 342 in the second coding tree 320 corresponds to a node position of the first node unit 341 in the first coding tree 310. In other words, the decision tree module 300 selects the coding units 431 at the corresponding positions from the first coding tree 310 and the second coding tree 320 according to the first coding block 351. For convenience of description, the first node unit 341 is used to represent the first coding block 351, and the second node unit 342 is used to represent the second coding block 352 below. The decision tree module 300 selects either the first node unit 341 or the second node unit 342 as an output node 345 according to the splitting of the target block 430 and the combination of the coding units 431 (refer to FIG. 2). The output node 345 includes the composition structure of the coding unit 431 in the above node unit.

Similarly, the decision tree module 300 further selects the third node unit 343 from the first coding tree 310 and the fourth node unit 344 from the second coding tree 320 according to the second coding block 352. In addition, the decision tree module 300 selects the third node unit 343 or the fourth node unit 344 as another output node 345 according to the composition structure of the coding units 431 of the third node unit 343 and the fourth node unit 344. The decision tree module 300 traverses the first coding tree 310 and the second coding tree 320 and obtains all of the output nodes 345. Generally speaking, the decision tree module 300 may traverse the coding trees in a zigzag manner, as indicated by an arrow in FIG. 4B. The decision tree module 300 still traverses the node units among different coding blocks in a zigzag manner after traversing inside of the same coding block, as shown in FIG. 4C. The decision tree module 300 builds the output decision tree 330 according to the output node 345, as shown in FIG. 4D. FIG. 4E is a schematic diagram of a tree structure of the output decision tree of FIG. 4D. For example, a root node of the output decision tree 330 in FIG. 4E includes four sub-nodes. The four sub-nodes respectively correspond to the coding units 431 of the output decision tree 330. For example, left subtrees of FIG. 4E correspond to the coding units 431 at the upper left of the output decision tree 330 (i.e., at a dashed box). Similarly, a second subtree on the left is the coding unit 431 at the upper right of the output decision tree 330, and therefore the subtree includes only a single node. The remaining subtrees may have a similar correspondence.

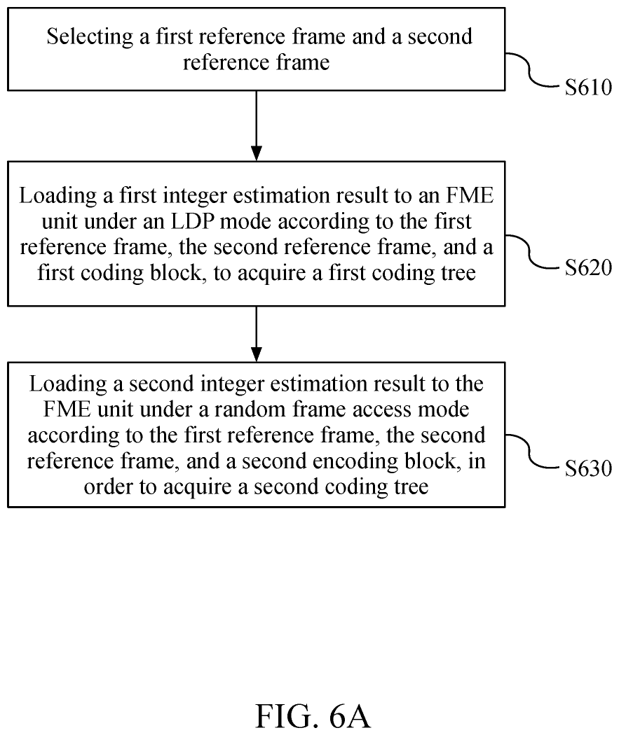

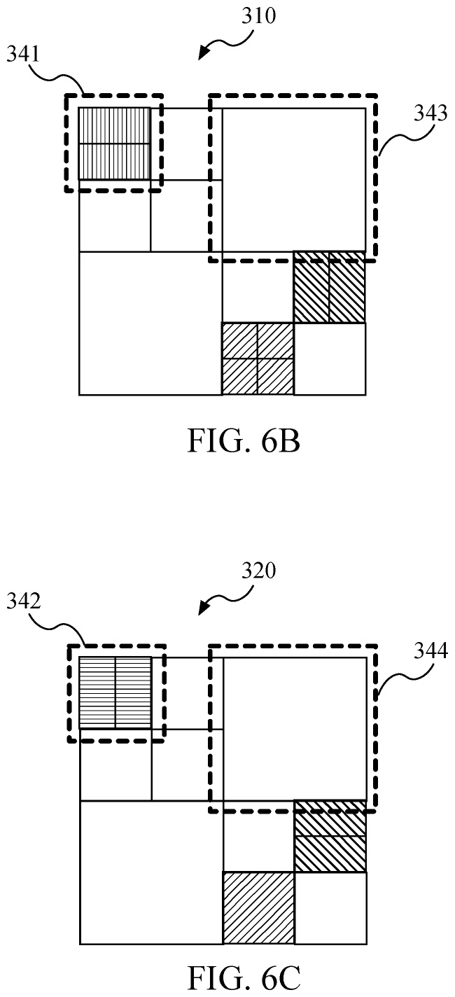

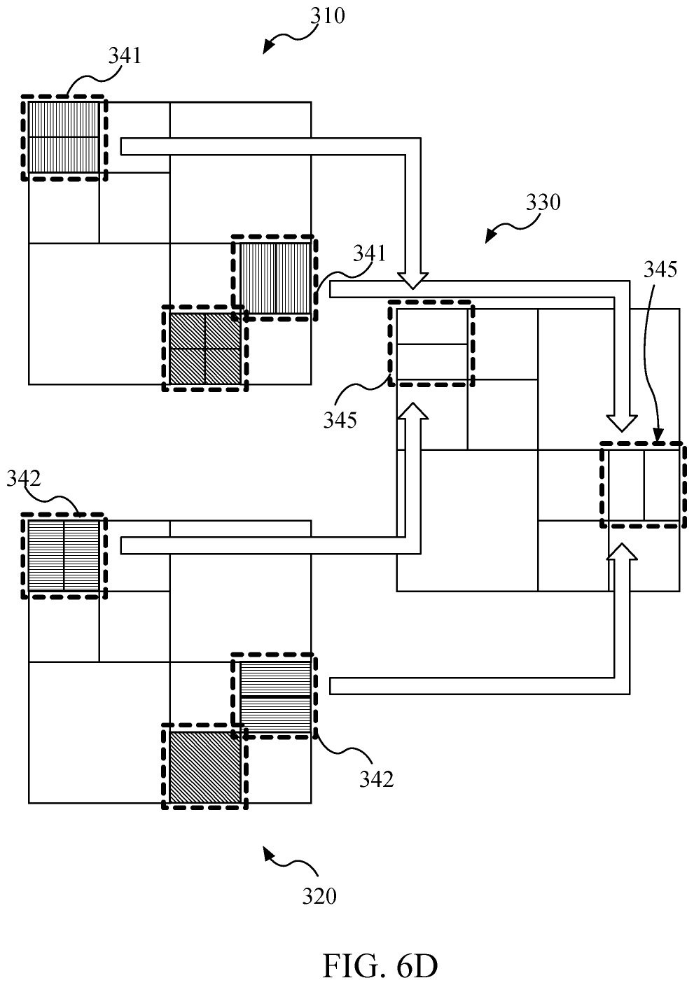

In an embodiment, in the generation process of the first coding tree 310 and the second coding tree 320, the coding trees may be divided according to different quantities of reference frames. Referring to FIG. 6A, this embodiment further includes the following processing steps. FIG. 6A is a schematic diagram of a processing flow of generating coding trees in an LDP mode according to an embodiment of the present disclosure.
Step S610: a first reference frame and a second reference frame are selected.
Step S620: a first integer estimation result is loaded to an EME unit under an LDP mode according to the first reference frame, the second reference frame, and a first coding block, to acquire a first coding tree.
Step S630: a second integer estimation result is loaded to the FME unit under a random frame access mode according to the first reference frame, the second reference frame, and a second coding block, in order to acquire a second coding tree.

The electronic device 1 selects any two from the frames 410 other than the target block 430, which are respectively the first reference frame and the second reference frame. The IME unit 210 applies the first integer estimation result 441 to the first reference frame and the second reference frame, and performs prediction processing of the first coding block 351, the second coding block 352, and the LDP mode. The IME unit 210 applies the second integer estimation result 442 to the first reference frame and the second reference frame, and performs prediction processing of the first coding block 351, the second coding block 352, and the random frame access mode (RA mode).

In some embodiments, the first coding block 351 has a size of 16*16 pixels, and the second coding block 352 has a size of 32*32 pixels. The IME unit 210 performs the prediction processing on the target block 430, and outputs the first integer estimation result 441 and the second integer estimation result 442. Referring to FIG. 6B and FIG. 6C, the FME unit 220 and the coding mode decision unit 230 perform division of the coding units 431 on the first integer estimation result 441 and the second integer estimation result 442 by using the first coding block 351.

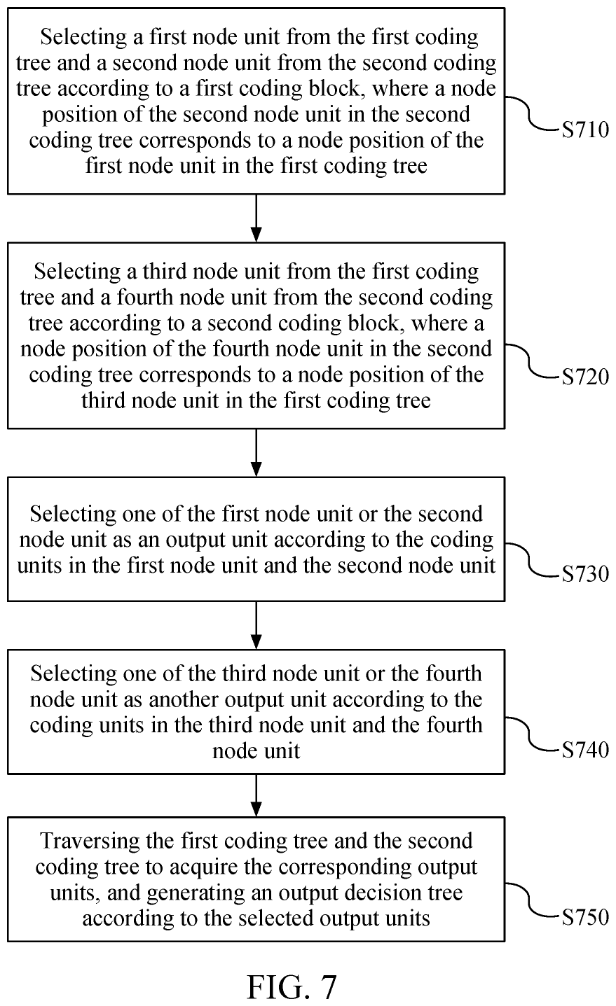

FIG. 6B shows an output result of applying the first integer estimation result 441 to the first reference frame and the second reference frame and processing the first integer estimation result based on the LDP mode in a manner similar to that for the first coding block 351 and the second coding block 352 in FIG. 4B and FIG. 4C. In FIG. 6B, an area filled with vertical lines represents the first coding block 351 (i.e., the first node unit 341). In FIG. 6C, an area filled with horizontal lines represents the second coding block 352 (i.e., the second node unit 342). In this embodiment, referring to FIG. 7, the IME unit 210 further includes the following steps during the processing of the first coding block and the second coding block.
Step S710: a first node unit is selected from the first coding tree and a second node unit is selected from the second coding tree according to the first coding block, where a node position of the second node unit in the second coding tree corresponds to a node position of the first node unit in the first coding tree.
Step S720: a third node unit is selected from the first coding tree and a fourth node unit is selected from the second coding tree according to the second coding block, where a node position of the fourth node unit in the second coding tree corresponds to a node position of the third node unit in the first coding tree.
Step S730: one of the first node unit or the second node unit is selected as an output unit according to the coding units in the first node unit and the second node unit.
Step S740: one of the third node unit or the fourth node unit is selected as another output unit according to the coding units in the third node unit and the fourth node unit.
Step S750: the first coding tree and the second coding tree are traversed to acquire the corresponding output units, and an output decision tree is generated according to the selected

The decision tree module 300 selects the coding units 431 from the first coding tree 310 by using the first coding block 351, and uses the selected coding units 431 (or a set of coding units 431) as a first node unit 341. The decision tree module 300 selects the second node unit 342 from the second coding tree 320. The node position of the second node unit 342 corresponds to the node position of the first node unit 341. The decision tree module 300 selects either the first node unit 341 or the second node unit 342 as the output node 345 according to the composition structure of the coding units 431 of the first node unit 341 and the second node unit 342.

Referring to FIG. 6B and FIG. 6C, the decision tree module 300 further selects the third node unit 343 from the first coding tree 310 and the fourth node unit 344 from the second coding tree 320 according to the second coding block 352. In addition, the decision tree module 300 selects the third node unit 343 or the fourth node unit 344 as another output node 345 according to the composition structure of the coding units 431 of the third node unit 343 and the fourth node unit 344. In FIG. 6B and FIG. 6C, since the third node unit 343 and the fourth node unit 344 correspond to the composition structure of the same coding unit 431, the decision tree module 300 selects the third node unit 343 directly. Then, the decision tree module 300 traverses the first coding tree 310 and the second coding tree 320 and obtains all of the output nodes 345. The decision tree module 300 generates the output decision tree 330 according to the acquired output node 345, as shown in FIG. 6D.

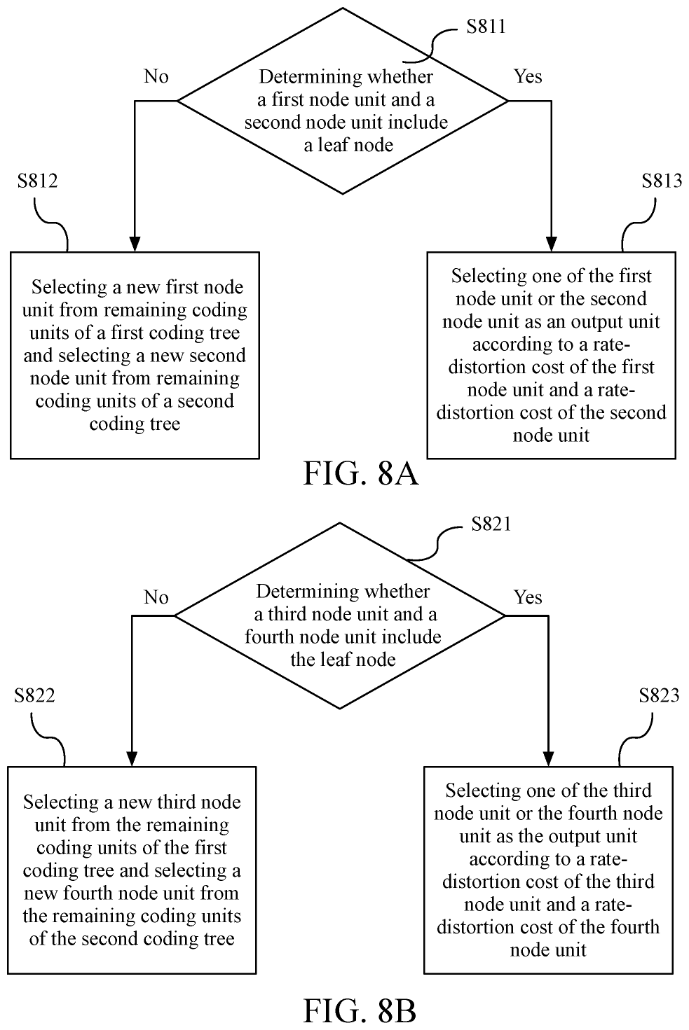

In an embodiment, after the IME unit 210 generates the first integer estimation result 441 and the second integer estimation result 442, the FME unit 220 further determines whether each node unit includes a leaf node. It is noted that the node unit may be composed of a single coding unit 431 or a plurality of coding units 431, and therefore the plurality of coding units 431 form a tree structure. Referring to FIG. 8A and FIG. 8B, FIG. 8A and FIG. 8B are respectively schematic diagrams of an operation process of a selection output unit according to an embodiment of the present disclosure. The IME unit 210 determines the first node unit 341 and the second node unit 342 in the following processing flow.
Step S811: whether the first node unit and the second node unit include a leaf node is determined.
Step SS12: a new first node unit is selected from remaining coding units of the first coding tree and a new second node unit is selected from remaining coding units of the second coding tree, if neither the first node unit nor the second node unit includes the leaf node.
Step S813: one of the first node unit or the second node unit is selected as the output unit according to a rate-distortion cost of the first node unit and a rate-distortion cost of the second node unit, if either the first node unit or the second node unit includes the leaf node.

The FME unit 220 determines whether the first node unit 341 and the second node unit 342 each include the leaf node. Since the first node unit 341 (or the second node unit 342) may include more than two coding units 431, the first node unit 341 (or the second node unit 342) forms the tree structure. Taking FIG. 6B as an example, the first node unit 341 in FIG. 6B includes two coding units 431. If neither the first node unit 341 nor the second node unit 342 includes the leaf node, the FME unit 220 selects the new first node unit 341 from the remaining coding units 431 of the first coding tree 310. Besides, the FME unit 220 also selects the new second node unit 342 at the corresponding node position from the second coding tree 320 according to the node position of the new first node unit 341.

If one of the first node unit 341 or the second node unit 342 includes the leaf node, the FME unit 220 compares the rate-distortion cost of the first node unit 341 with the rate-distortion cost of the second node unit 342 and determines whether a difference between the two rate-distortion costs exceeds a threshold. If the difference between the two rate-distortion costs exceeds the threshold, the FMF unit 220 selects the first node unit 341 as the output unit, which has the same structure as the coding block filled with vertical lines in FIG. 6B. Conversely, when the difference between the two rate-distortion costs fails to exceed the threshold, the FME unit 220 selects the second node unit 342 as the output unit, which has the same structure as the coding block filled with horizontal lines in FIG. 6C. The coding tree generation module 200 performs momentum prediction on the first reference frame and the second reference frame by using the first coding tree 310.

The FME unit 220 determines the third node unit 343 and the fourth node unit 344 with the following processing flow:
Step S821: whether the third node unit and the fourth node unit include a leaf node is determined.
Step S822: a new third node unit is selected from the remaining coding units of the first coding tree and a new fourth node unit is selected from the remaining coding units of the second coding tree, if neither the third node unit nor the fourth node unit includes the leaf node.
Step S823: one of the third node unit or the fourth node unit is selected as the output unit according to a rate-distortion cost of the third node unit and a rate-distortion cost of the fourth node unit, if either the third node unit or the fourth node unit includes the leaf node.

The FME unit 220 determines whether the third node unit 343 and the fourth node unit 344 each include the leaf node. The FME unit 220 acquires the corresponding output node 345 according to the above processing, and builds the first coding tree 310 and the second coding tree 320. The decision tree module 300 performs momentum prediction on the first reference frame according to the first coding tree 310 and the second coding tree 320. In FIG. 6B, since neither the third node unit 343 nor the fourth node unit 344 includes the leaf node (the structure includes only one combination), the decision tree module 300 selects the third node unit 343 as the output node 345 directly. Finally, the decision tree module 300 generates the corresponding output decision tree 330 according to the output nodes 345 obtained by the first node unit 341, the second node unit 342, the third node unit 343, and the fourth node unit 344, as shown in FIG. 6D.

The method for processing video coding and the electronic device 1 perform coding prediction on a plurality of frames 410 of the input image 400, to output streaming data. In the method for processing video coding, the coding trees are divided in advance, to generate two different sets of coding trees. Different coding trees are processed by using corresponding rate-distortion costs, to reduce computational loads of the coding trees. The output decision tree 330 is generated according to the nodes formed by the first coding tree 310 and the second coding tree 320. The method for processing video coding can reduce the computational complexity of a hardware coder and can maintain the same coding quality.

What is claimed is:

1. A method for processing video coding, for performing coding prediction on one of a plurality of frames of an input image and comprising:
acquiring a target block in the frame;
loading the target block to a coding tree generation module to output a first coding tree and a second coding tree;
generating an output decision tree according to the first coding tree and the second coding tree; and
outputting streaming data according to the output decision tree and the frame.

2. The method for processing video coding according to claim 1, wherein the step of loading the target block to the coding tree generation module to output the first coding tree and the second coding tree comprises:
splitting the target block into at least one coding unit;
calculating, by an integer motion estimation (IME) unit of the coding tree generation module, a rate-distortion cost of each of the coding units; and
selecting a smallest one and a second smallest one from all of the rate-distortion costs, wherein the smallest rate-distortion cost is a first integer estimation result, and the second smallest rate-distortion cost is a second integer estimation result.

3. The method for processing video coding according to claim 2, wherein the step of selecting the smallest one and the second smallest one from all of the rate-distortion costs comprises:
loading the first integer estimation result to a fractional motion estimation (FME) unit of the coding tree generation module to obtain a first fractional estimation result;
loading the first fractional estimation result to a coding mode decision unit of the coding tree generation module to obtain the first coding tree;
loading the second integer estimation result to the FME unit to obtain a second fractional estimation result; and
loading the second fractional estimation result to the coding mode decision unit to obtain the second coding tree.

4. The method for processing video coding according to claim 2, wherein the step of loading the target block to the coding tree generation module to output the first coding tree and the second coding tree comprises:
selecting a first reference frame;
loading the first integer estimation result to an FME unit in a low delay P frame (LDP) mode according to the first reference frame, a first coding block, and a second coding block, to acquire the first coding tree; and
loading the second integer estimation result to the FME unit in the LDP mode according to the first reference frame, the first coding block, and the second coding block, to acquire the second coding tree.

5. The method for processing video coding according to claim 4, wherein the step of generating the output decision tree according to the first coding tree and the second coding tree comprises:
selecting a first node unit from the first coding tree and a second node unit from the second coding tree according to the first coding block, wherein a node position of the second node unit in the second coding tree corresponds to a node position of the first node unit in the first coding tree;
selecting a third node unit from the first coding tree and a fourth node unit from the second coding tree according to the second coding block, wherein a node position of the fourth node unit in the second coding tree corresponds to a node position of the third node unit in the first coding tree;
selecting one of the first node unit or the second node unit as an output unit according to the coding units in the first node unit and the second node unit;
selecting one of the third node unit or the fourth node unit as another output unit according to the coding units in the third node unit and the fourth node unit; and
traversing the first coding tree and the second coding tree to acquire the corresponding output units, and generating the output decision tree according to the selected output units.

6. The method for processing video coding according to claim 2, wherein the step of loading the target block to the coding tree generation module to output the first coding tree and the second coding tree comprises:
selecting a first reference frame and a second reference frame;
loading the first integer estimation result to an FME unit under an LDP mode according to the first reference frame, the second reference frame, and a first coding block, to acquire the first coding tree; and
loading the second integer estimation result to the FME unit under a random frame access mode according to the first reference frame, the second reference frame, and a second coding block, to acquire the second coding tree.

7. The method for processing video coding according to claim 6, wherein the step of generating the output decision tree according to the first coding tree and the second coding tree comprises:
selecting a first node unit from the first coding tree and a second node unit from the second coding tree according to the first coding block, wherein a node position of the second node unit in the second coding tree corresponds to a node position of the first node unit in the first coding tree;
selecting a third node unit from the first coding tree and a fourth node unit from the second coding tree according to the second coding block, wherein a node position of the fourth node unit in the second coding tree corresponds to a node position of the third node unit in the first coding tree;
selecting one of the first node unit or the second node unit as an output unit according to the coding units in the first node unit and the second node unit;
selecting one of the third node unit or the fourth node unit as another output unit according to the coding units in the third node unit and the fourth node unit; and
traversing the first coding tree and the second coding tree to acquire the corresponding output units, and generating the output decision tree according to the selected output units.

8. The method for processing video coding according to claim 7, wherein the step of traversing the first coding tree and the second coding tree to acquire the corresponding output units, and generating the output decision tree according to the selected output units comprises:
determining whether the first node unit and the second node unit comprise a leaf node;
selecting a new first node unit from remaining coding units of the first coding tree and selecting a new second node unit from remaining coding units of the second coding tree, if neither the first node unit nor the second node unit comprises the leaf node; and
selecting one of the first node unit or the second node unit as the output unit according to the rate-distortion cost of the first node unit and the rate-distortion cost of the second node unit, if either the first node unit or the second node unit comprises the leaf node.

9. The method for processing video coding according to claim 7, wherein the step of traversing the first coding tree and the second coding tree to acquire the corresponding output units, and generating the output decision tree according to the selected output units comprises:
determining whether the third node unit and the fourth node unit comprise the leaf node;
selecting a new third node unit from remaining coding units of the first coding tree and selecting a new fourth node unit from remaining coding units of the second coding tree, if neither the third node unit nor the fourth node unit comprises the leaf node; and
selecting one of the third node unit or the fourth node unit as the output unit according to the rate-distortion cost of the third node unit and the rate-distortion cost of the fourth node unit, if either the third node unit or the fourth node unit comprises the leaf node.

10. An electronic device for processing video coding, comprising:
a storage unit, configured to store an input image, wherein the input image comprises a plurality of frames;
a coding tree generation module, configured to acquire a target block from any of the frames and generate a first coding tree and a second coding tree according to the target block; and
a decision tree module, configured to receive the first coding tree and the second coding tree and generate an output decision tree according to a plurality of rate-distortion costs of the first coding tree and the second coding tree.

11. The electronic device for processing video coding according to claim 10, wherein the coding tree generation module further comprises an integer motion estimation (IME) unit, a fractional motion estimation (FME) unit, and a coding mode decision unit, the IME unit is configured to generate a first integer estimation result and a second integer estimation result according to the target block, the FME unit is configured to generate a first fractional estimation result according to the first integer estimation result and generate a second fractional estimation result according to the second integer estimation result, and the coding mode decision unit is configured to generate the first coding tree and the second coding tree according to the first fractional estimation result and the second fractional estimation result.

12. The electronic device for processing video coding according to claim 10, wherein the IME unit is configured to select a smallest one of the rate-distortion costs as a first integer estimation result and select a second smallest one of the rate-distortion costs as a second integer estimation result.

13. The electronic device for processing video coding according to claim 10, wherein the coding tree generation module is configured to perform, during outputting of the second coding tree, the following steps to acquire the target block of a first reference frame: loading the target block to an FME unit under an LDP mode according to the first reference frame and a first coding block, to acquire the first coding tree; and loading the target block to the FME unit under the LDP mode according to the first reference frame and a second coding block, to acquire the second coding tree.

14. The electronic device for processing video coding according to claim 13, wherein the decision tree module is configured to: select a first node unit from the first coding tree and a second node unit from the second coding tree according to the first coding block, wherein a node position of the second node unit in the second coding tree corresponds to a node position of the first node unit in the first coding tree; select a third node unit from the first coding tree and a fourth node unit from the second coding tree according to the second coding block, wherein a node position of the fourth node unit in the second coding tree corresponds to a node position of the third node unit in the first coding tree; select one of the first node unit or the second node unit as an output unit according to the coding units in the first node unit and the second node unit; select one of the third node unit or the fourth node unit as the output unit according to the coding units in the third node unit and the fourth node unit; and traverse the first coding tree and the second coding tree to acquire the corresponding output units, and generate the output decision tree according to the selected output units.

15. The electronic device for processing video coding according to claim 10, wherein the coding tree generation module is configured to perform, during outputting of the second coding tree, the following steps to acquire a first target block of a first reference frame: acquiring a second target block of a second reference frame, wherein a position of the second target block corresponds to a position of the first target block; loading the first target block to an FME unit under an LDP mode according to the first reference frame, the second reference frame, and a first coding block, to acquire the first coding tree; and loading the second target block to the FME unit under a random frame access mode according to the first reference frame, the second reference frame, and a second coding block to acquire the second coding tree.
